(19) United States
(12) Patent Application Publication
(10) Pub. No.: US 2016/0006296 A1
(43) Pub. Date: Jan. 7, 2016

(54) Systems And Methods For Matching End Of Life For Multiple Batteries And/Or Battery Backup Units

(71) Applicant: Emerson Network Power, Energy Systems, North America, Inc., Warrenville, IL (US)

(72) Inventor: Michael Francis SMITH, Columbia Station, OH (US)

(21) Appl. No.: 14/788,100

(22) Filed: Jun. 30, 2015

Related U.S. Application Data
(60) Provisional application No. 62/020,201, filed on Jul. 2, 2014.

(51) Int. Cl. H02J 9/06

(52) U.S. Cl. CPC H02J 9/06

(57) ABSTRACT

A system includes a first converter, a second converter, a first rechargeable battery configured to output a current to the first converter, a second rechargeable battery configured to output a current to the second converter, and a control circuit coupled to the converters. Each rechargeable battery has a capacity and a number of remaining discharge cycles. The control circuit is configured to determine a remaining lifetime energy throughput of the first rechargeable battery and the second rechargeable battery based on their respective capacity and number of remaining discharge cycles, and in response to the remaining lifetime energy throughput of the first rechargeable battery and the remaining lifetime energy throughput of the second rechargeable battery not being substantially equal, control the first converter to adjust the current from the first rechargeable battery to change a rate of decrease of the remaining lifetime energy throughput of the first rechargeable battery.

### CROSS-REFERENCE TO RELATED APPLICATION

This application claims the benefit of U.S. Provisional Application No. 62/020,201 filed Jul. 2, 2014.

### FIELD

The present disclosure relates to systems and methods for matching end of life for multiple batteries and/or battery backup units.

### BACKGROUND

This section provides background information related to the present disclosure which is not necessarily prior art.

Electrical power systems oftentimes include a primary power source and a backup power source for providing backup power to a load when the primary power source is unable to satisfy load requirements due to, for example, a loss of input power, malfunction, etc. Commonly, the backup power source includes one or more rechargeable batteries. In such cases, the batteries may power the load until one or more of the batteries are unable to do so (e.g., the battery reaches its end of life). Typically, the rechargeable batteries provide equal currents to the load (e.g., commonly referred to as “load balancing”).

### SUMMARY

This section provides a general summary of the disclosure, and is not a comprehensive disclosure of its full scope or all of its features.

According to one aspect of the present disclosure, a system for providing power to a load includes a first converter, a second converter, a first rechargeable battery configured to output a current to the first converter, a second rechargeable battery configured to output a current to the second converter, and a control circuit coupled to the first converter and the second converter. Each rechargeable battery has a capacity and a number of remaining discharge cycles. The control circuit is configured to determine a remaining lifetime energy throughput of the first rechargeable battery and the second rechargeable battery based on their respective capacity and number of remaining discharge cycles, and in response to the remaining lifetime energy throughput of the first rechargeable battery and the remaining lifetime energy throughput of the second rechargeable battery not being substantially equal, control the first converter to adjust the current from the first rechargeable battery to change a rate of decrease of the remaining lifetime energy throughput of the first rechargeable battery.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram of a system including two rechargeable batteries, two converters, and a control circuit for controlling the converters according to one example embodiment of the present disclosure.

FIG. 2 is a block diagram of a system including the two converters of FIG. 1 coupled to different load(s) according to another example embodiment.

FIG. 3 is a block diagram of a system including the two converters of FIG. 1 coupled to the same load(s) according to yet another example embodiment.

FIG. 4 is a block diagram of a system including three rechargeable batteries, three converters, and a control circuit for controlling the converters according to another example embodiment.

FIG. 5 is a block diagram of a system including two battery backup units (BBUs) each having rechargeable batteries and a converter, and a control circuit for controlling each converter according to yet another example embodiment.

FIG. 6 is a block diagram of a system including two BBUs each having rechargeable batteries, a converter, and a control circuit for controlling the converter according to another example embodiment.

FIG. 7 is a block diagram of a BBU including an input converter, rechargeable batteries coupled to the input converter, and an output converter coupled to the rechargeable batteries and the input converter according to yet another example embodiment.

FIG. 8 is a block diagram of a system including a primary power source and three BBUs coupled to the primary power source according to another example embodiment.

Corresponding reference numerals indicate corresponding parts or features throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

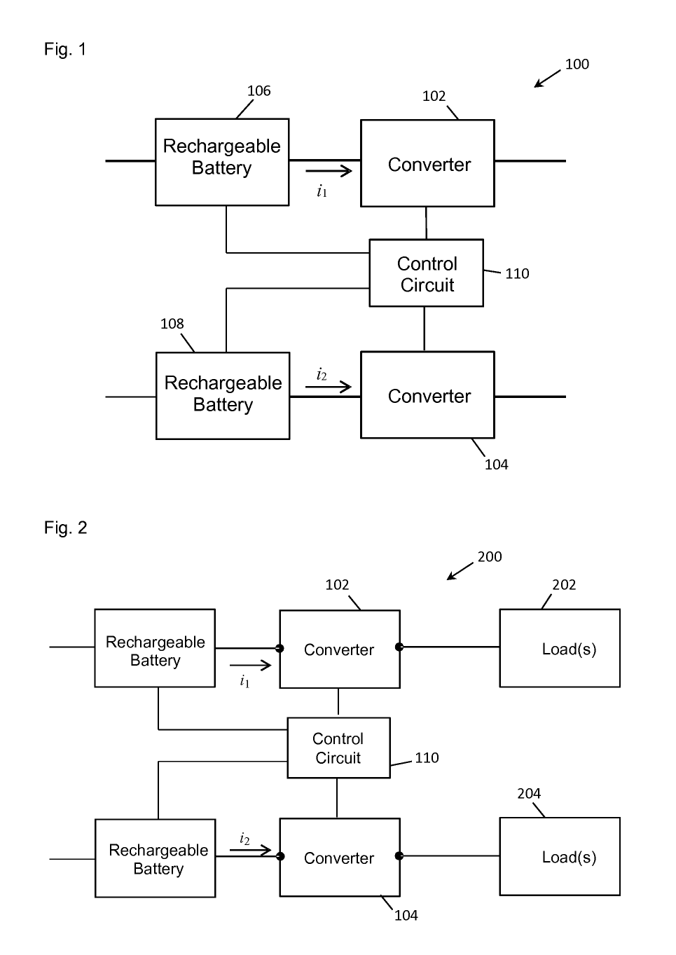

A system for providing power to a load according to one example embodiment of the present disclosure is illustrated in FIG. 1 and indicated generally by reference number 100. As shown in FIG. 1, the system 100 includes converters 102, 104, rechargeable batteries 106, 108 for outputting currents i1, i2 to the converters 102, 104, respectively, and a control circuit 110 coupled to the converters 102, 104. Each rechargeable battery 106, 108 has a capacity and a number of remaining discharge cycles. The control circuit 110 determines a remaining lifetime energy throughput of the rechargeable batteries 106, 108 based on their respective capacity and number of remaining discharge cycles, and in response to the remaining lifetime energy throughput of the rechargeable battery 106 and the remaining lifetime energy throughput of the rechargeable battery 108 not being substantially equal, controls one of the converters (e.g., the converter 102) to adjust its input current i1 from the rechargeable battery 106 to change a rate of decrease of the remaining lifetime energy throughput of the rechargeable battery 106.

For example, each rechargeable battery 106, 108 may have a different time to its end of life (EOL). This may be due to the age of the batteries, the number of charge cycles of the batteries, the environment conditions, etc. As such, one of the rechargeable batteries (e.g., the battery 106) may reach its EOL before the other rechargeable battery (e.g., the battery 108).

However, by changing a rate of decrease of a remaining lifetime energy throughput of one or both rechargeable batteries 106, 108, an estimated time of when one or both rechargeable batteries will reach their EOL changes as further explained below. As a result, the time to EOL of each rechargeable battery 106, 108 may become substantially equal at a later point in time. Therefore, each rechargeable battery 106, 108 may reach its EOL at substantially the same time and thus be replaced at the same time. As such, the number of man-hours, trips, etc. needed to replace dead batteries, battery units, etc. may be reduced as compared to systems including batteries not having this matching EOL control scheme disclosed herein. Additionally, by having each battery 106, 108 reach its EOL at substantially the same time, the number of batteries, battery units, etc. replaced per trip may be increased.

Further, multiple batteries are often replaced in prior art systems when one of the batteries has reached its EOL regardless of the condition of the other batteries. Thus, usable batteries in the prior art systems are often unnecessarily replaced and therefore wasted. However, by employing the teachings disclosed herein, multiple batteries in a system reach their EOL at the same time, and therefore can be replaced at the same time without wasting usable batteries.

As explained above, the remaining lifetime energy throughput (sometimes referred to as a lifetime energy capacity) of each rechargeable battery 106, 108 is based on a capacity and a number of remaining discharge cycles. For example, the remaining lifetime energy throughput represents a total amount of energy which can be drawn from a rechargeable battery over its remaining cycles. In some embodiments, the remaining lifetime energy throughput may be a total amount of energy over the remaining cycles of the battery before the battery's capacity reduces to some fraction of its initial capacity, such as eight-five percent, eighty percent, seventy percent, fifty percent, etc. As such, the remaining lifetime energy throughput of a rechargeable battery may be determined by multiplying a battery's capacity (sometimes referred to as a usable energy) by its number of remaining discharge cycles.

For example, the rechargeable battery 106 may have a capacity of about 75 W-Hr (e.g., 3 kW max for 90 sec, 1.5 kW max for 180 sec, etc.) and fifteen remaining discharge cycles, and the rechargeable battery 108 may have a capacity of about 75 W-Hr and ten remaining discharge cycles. In this particular example, the remaining lifetime energy throughput of the battery 106 is 1,125 (i.e., 75 W-Hr×fifteen remaining discharges) and the remaining lifetime energy throughput of the battery 108 is 750 (i.e., 75 W-Hr×ten remaining discharges). Thus, the battery 106 (having the higher remaining lifetime energy throughput) has a longer time to its EOL than the battery 108 (having the lower remaining lifetime energy throughput).

Because the batteries 106, 108 do not have a substantially equal remaining lifetime energy throughput, the battery current i1, i2 from one or both batteries 106, 108 may be adjusted by controlling one or both converters 102, 104. For example, if the battery current i1 from the battery 106 is increased and the battery current i2 from the battery 108 remains unchanged or decreases (as further explained below), the rate of decrease of a remaining lifetime energy throughput of the battery 106 would increase relative to the rate of decrease of a remaining lifetime energy throughput of the battery 108. Alternatively, if the battery current i1 from battery 106 is decreased and the battery current i2 from battery 108 remains unchanged or increases, the rate of decrease of a remaining lifetime energy throughput of the battery 106 would decrease relative to the rate of decrease of a remaining lifetime energy throughput of the battery 108.

Therefore, the battery current i1 from the battery 106 (having the higher remaining lifetime energy throughput) may be increased by controlling the converter 102 such that the battery 106 provides a higher percentage of power required by load(s) coupled to one or both converters 102, 104 as compared to the battery 108. By doing so, the battery 106 discharges faster and therefore needs to be recharged sooner than the battery 108. Accordingly, the number of remaining discharges cycles in the battery 106 and/or the capacity of the battery 106 may decrease at a faster rate as compared to the battery 108. Thus, the remaining lifetime energy throughput (which is based on the remaining discharges cycles and the capacity) of the battery 106 may decrease at a faster rate than the remaining lifetime energy throughput of the battery 108. As a result, the remaining lifetime energy throughput of each battery 106, 108 may become substantially equal (at some point in time) and thus a time to EOL of each rechargeable battery 106, 108 may become substantially equal.

The number of remaining discharge cycles is a number of complete charge and discharge cycles remaining that a battery can perform. In some embodiments, this number of complete charge and discharge cycles includes the cycles remaining that a battery can perform before its capacity falls below some fraction of its initial capacity, such as eight-five percent, eighty percent, seventy percent, etc.

The number of remaining discharge cycles may be dependent on, for example, the length of each discharge period (e.g., 90 sec, 180 sec, etc.), the discharge power over a discharge period (e.g., 3 kW, 1.5 kW, etc.), the age of the battery, the environment conditions (e.g., temperature), etc. As such, the number of remaining discharge cycles for each battery may decrease nonlinearly and/or linearly at any given time.

The number of remaining discharge cycles may be determined in any suitable manner. For example, the control circuit 110 may determine a number of remaining discharge cycles based on user input, one or more parameters of the system 100, etc. In some embodiments, a user may input specifications of a particular battery, a battery model number, a preset number of discharges remaining, etc. In such examples, the control circuit 110 can determine the number of remaining discharge cycles by using the user inputted data and one or more lookup tables stored in memory. Additionally and/or alternatively, the control circuit 110 may receive sensed parameters of an input and/or output current, an input and/or output voltage, temperature, etc. of the system 100 to determine the number of remaining discharge cycles.

In some embodiments, the control circuit 110 receive an initial number of remaining discharge cycles (e.g., a preset value) when each rechargeable battery 106, 108 is installed. This initial number may be provided by the manufacturer, determined based on manufacturer specifications, estimated, etc. After the initial number of remaining discharge cycles is set, the control circuit 110 may monitor one or more parameters of the system 100 to determine a number of remaining discharge cycles. For example, and as shown in FIG. 1, the control circuit 110 is coupled to the batteries 106, 108. As such, the control circuit 110 may monitor (e.g., sense, etc.) an output and/or an input of one or both batteries 106, 108 to detect each battery charge and/or battery discharge of one or both batteries. In some embodiments, the control circuit 110 may include a counter to count each battery charge and/or battery discharge. A number of remaining discharge cycles may then be determined by subtracting the number of battery charges, the number of battery discharges, etc. from the preset number of remaining discharge cycles.

As mentioned above, the converter 102 is controllable to adjust the current i1 from its respective battery 106. For example, the converter 102 may be controlled to increase and/or decrease the battery current i1. In some embodiments, the current i1 may be adjusted by adjusting a regulated output voltage of the converter 102. In such cases, the converter 102 is controlled to regulate its output voltage to a defined setpoint as required by a load. The defined setpoint may be, for example, 12 VDC, 48 VDC, etc. If it is desired to adjust the current i1 from the battery 106, the defined setpoint may be adjusted (e.g., reduced and/or increased).

For example, the output voltage setpoint may be decreased from 12 VDC to 11.999 VDC, increased from 48 VDC to 48.001 VDC, etc. This causes the output current of the converter 102 to adjust which causes the converter's 102 input current (i.e., the current i1 drawn from the rechargeable battery 106) to change. As a result, the rate of decrease of a remaining lifetime energy throughput of the rechargeable battery 106 may be adjusted causing the time to EOL of the battery 106 to change as explained above.

In such an example, the output voltage of the converter 102 may be regulated near its originally defined setpoint (e.g., 12 VDC, 48 VDC, etc.) while controlling the battery current i1 to adjust a rate of decrease of a remaining lifetime energy throughput. As further explained below, this change in the setpoint voltage may be accomplished by adjusting a control signal (e.g., pulse width modulation (PWM), pulse frequency modulation (PFM), etc.) provided to a power switch in the converter 102 and/or by any other suitable method.

In other embodiments, one or both of the converter's input current may be regulated at a particular current level causing the current drawn from one or both batteries to adjust. As such, the rate of decrease of a remaining lifetime energy throughput of one or both batteries 106, 108 may be adjusted as explained above.

The battery currents i1, i2 from the batteries 106, 108 may be increased and/or decreased (as explained above) to any suitable level. For example, the converter 102 may be controlled to adjust the current i1 from the battery 106 to a maximum current of the battery 106 and/or the converter 104 may be controlled to adjust the current i2 from the battery 108 to a maximum current of the battery 108.

As explained above, when the current from one battery is adjusted, current from the other battery may also be adjusted. For example, if the converter 102 is controlled to increase the battery current i1 from the battery 106, the battery current i2 from the battery 108 may decrease to provide the remaining portion of a required load current. This decrease in battery current i2 may be caused by the controlling the converter 104 as explained above. In other embodiments, the battery current i2 may decrease without controlling the converter 104 as further explained below.

In the example embodiment of FIG. 1, one or both converters 102, 104 may be controlled to adjust the current i1, i2 from its respective battery 106, 108 until the time to EOL of each rechargeable battery 106, 108 is equal. For example, the control circuit 110 may control the converter 102 to adjust the current i1 from the battery 106 until its remaining lifetime energy throughput is substantially equal to the remaining lifetime energy throughput of the battery 108. At this point, the control circuit 110 may control the converters 102, 104 such that the batteries 106, 108 provide equal current to the load(s). If the remaining lifetime energy throughputs of the batteries 106, 108 become unequal again, the control circuit 110 may then control one or both converters 102, 104 to change a rate of decrease of the remaining lifetime energy throughput of at least one of the batteries 106, 108 as explained above.

Additionally, although each rechargeable battery 106, 108 is shown as one rechargeable battery in FIG. 1, it should be apparent that one or both rechargeable batteries 106, 108 may represent one rechargeable battery and/or a plurality of rechargeable batteries (e.g., a battery pack including multiple batteries, etc.). For example, the rechargeable battery 106 may include eight rechargeable batteries coupled together in parallel, series, and/or a combination of parallel and series, and the rechargeable battery 108 may include one rechargeable battery. As such, the control circuit 110 may determine a remaining lifetime energy throughput of each individual battery of rechargeable batteries, a pack of batteries of the rechargeable batteries, etc. as explained herein.

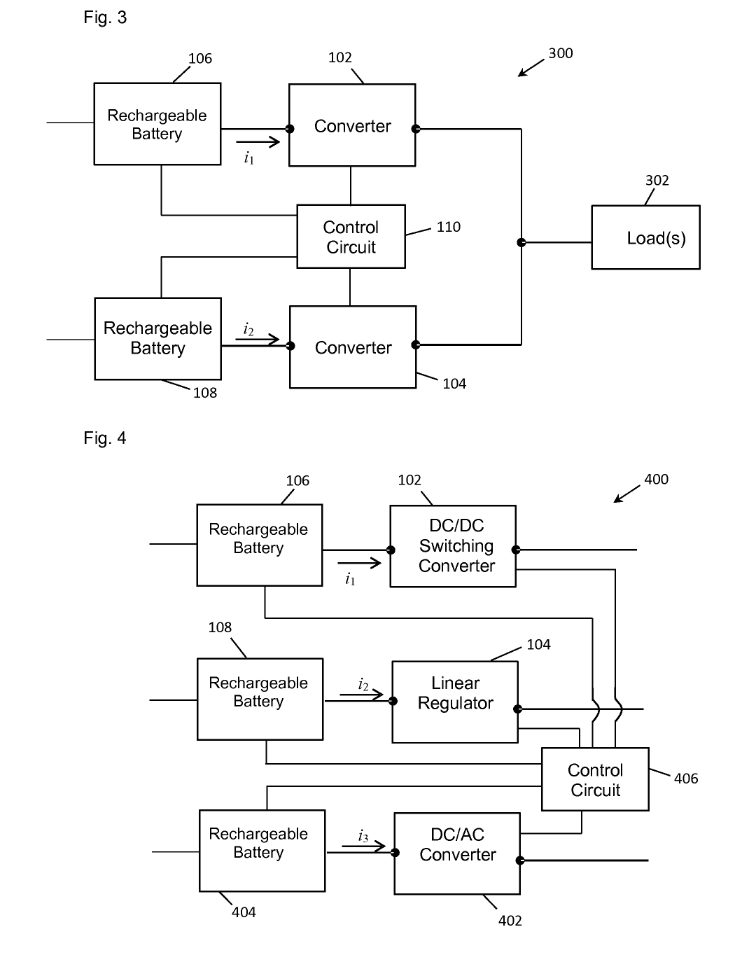

In some example embodiments, the converters 102, 104 may be coupled to one or more loads. For example, FIG. 2 illustrates a system 200 including the converter 102 coupled to load(s) 202, the converter 104 coupled to different load(s) 204, and the control circuit 110 of FIG. 1 coupled to the converters 102, 104. Alternatively, FIG. 3 illustrates a system 300 including the converter 102 and the converter 104 coupled to the same load(s) 302, and the control circuit 110 of FIG. 1 coupled to the converters 102, 104.

As shown in FIG. 3, the converter 102 and the converter 104 each include an output coupled in parallel. In such examples, current from one of the batteries 106, 108 of FIG. 3 may be adjusted without controlling its corresponding converter 102, 104. For example, the load(s) 302 may require a particular load current that is generally shared equally between the converters 102, 104. If the converter 102 of FIG. 3 is controlled to increase the battery current i1 by increasing its output current as explained above, the output current of the converter 104 is forced to decrease to provide the remaining current required by the load current. As a result, the battery current i2 drawn from the battery 108 decreases without controlling the converter 104. Thus, the control circuit 110 of FIG. 3 can control one of the two converters. Put more broadly, the control circuit 110 (as well as any other control circuit disclosed herein) may control N−1 converters in its system, where N equals the number of converters.

Although FIGS. 1-3 illustrate example systems including two rechargeable batteries and two converters, it should be apparent to those skilled in the art that any one of the systems may include more than two batteries and/or more than two converters without departing from the scope of the disclosure. For example, FIG. 4 illustrates another system 400 including the batteries 106, 108 and the converters 102, 104 of FIG. 1, a converter 402, a rechargeable battery 404 coupled to the converter 402, and a control circuit 406. Similar to the batteries 106, 108, the battery 404 has a capacity and a number of remaining discharge cycles.

The control circuit 406 of FIG. 4 is substantially similar to the control circuit 110 of FIG. 1. For example, and as shown in FIG. 4, the control circuit 406 is coupled to each converter 102, 104, 402 and determines a remaining lifetime energy throughput of each rechargeable battery 106, 108, 404 as explained above. The control circuit 406 may control one or more of the converters 102, 104, 402 as explained herein. For example, the control circuit 406 may control one or more of the converters 102, 104, 402 to adjust the current i1, i2, i3 from the rechargeable batteries 106, 108, 404 to change a rate of decrease of the remaining lifetime energy throughput of one or more corresponding batteries.

Additionally, and as shown in FIG. 4, the converter 102 includes a DC/DC switching converter, the converter 104 includes a linear regulator, and the converter 402 includes a DC/AC converter (e.g., commonly referred to as an inverter). It should be understood, however, the converters 102, 104, 402 (and/or any other converter disclosed herein) may be any suitable converter having any suitable topology (e.g., a buck converter, a boost converter, a buck/boost converter, a bridge converter, etc.). In some embodiments, the converters 102, 104, 402 may include one or more power switches for adjusting a setpoint voltage as explained above. In such examples, one or more of the converters may be a part of a switched mode power supply.

Further, although the converters 102, 104, 402 of FIG. 4 are shown as including different types of converters, it should be apparent that two or more of the converters 102, 104, 402 may include the same type of converter (e.g., a DC/DC converter, a DC/AC converter, etc.) if desired. For example, the converters 102, 104 may include a DC/DC switching converter having any suitable topology (e.g., one or more buck converters, boost converters, buck/boost converters, etc.) and the converter 402 may include a DC/AC converter.

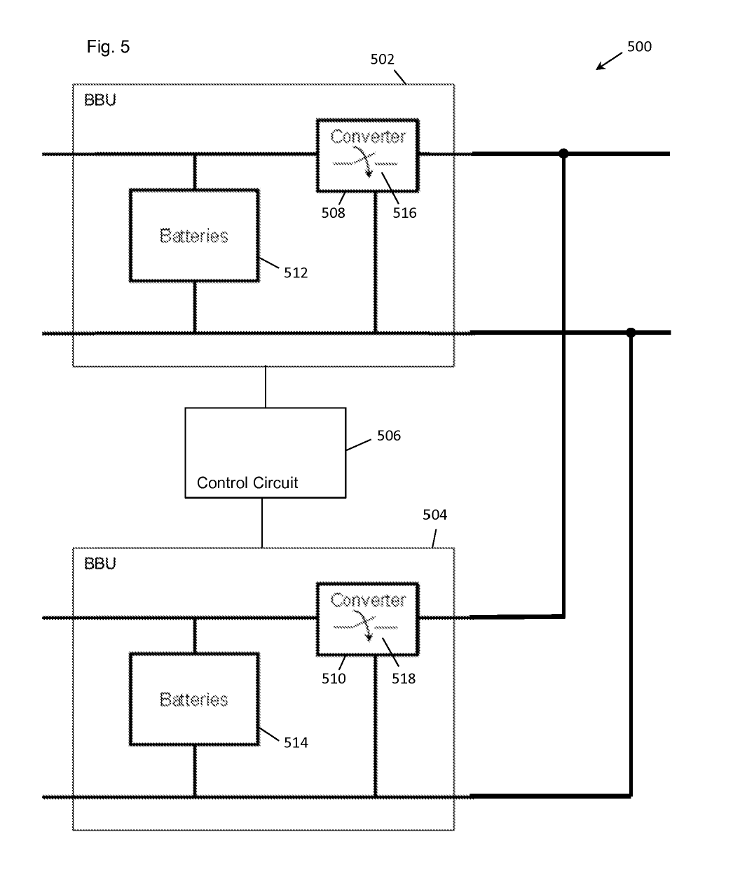

In some examples, the batteries and/or the converters disclosed herein may be components of a battery backup unit (BBU). For example, FIG. 5 illustrates a system 500 including two BBUs 502, 504 and a control circuit 506 coupled to each BBU 502, 504. Each BBU 502, 504 is capable of providing backup power to one or more loads (not shown) in the event a primary power source (not shown) is unable to do so due to, for example, a loss of input power, malfunction, etc.

Each BBU 502, 504 includes a converter 508, 510 and one or more rechargeable batteries 512, 514 coupled to an input of the converter 508, 510. The converters 508, 510 may include one or more DC/DC converters, DC/AC inverters, and/or any other suitable converter as explained herein.

The control circuit 506 of FIG. 5 may be substantial similar to the control circuit 110 of FIG. 1. As such, the control circuit 506 may determine a remaining lifetime energy throughput of the rechargeable batteries 512, 514 and control one or both converters 508, 510 to adjust a battery current from the batteries 512, 514 to change a rate of decrease of the remaining lifetime energy throughput of the batteries 512, 514 as explained herein

For example, the control circuit 506 may regulate one or both converter's 508, 510 output voltage to one or more defined setpoints by controlling one or more power switches 516, 518 of each converter 508, 510. This may be accomplished by controlling a control signal duty cycle of the power switches 516, 518. For example, the control circuit 506 may control the power switches 516, 518 by pulse width modulation (PWM), pulse frequency modulation (PFM), and/or another suitable control method.

As a result of regulating one or both converters 508, 510 at a different output voltage setpoint, the amount of current drawn from at least one of the batteries 512, 514 is adjusted as explained above.

In the example embodiment of FIG. 5, the batteries 512, 514 may be recharged by a primary power source. Additionally and/or alternatively, each BBU 502, 504 may include one or more converters for recharging the batteries 512, 514 as further explained below.

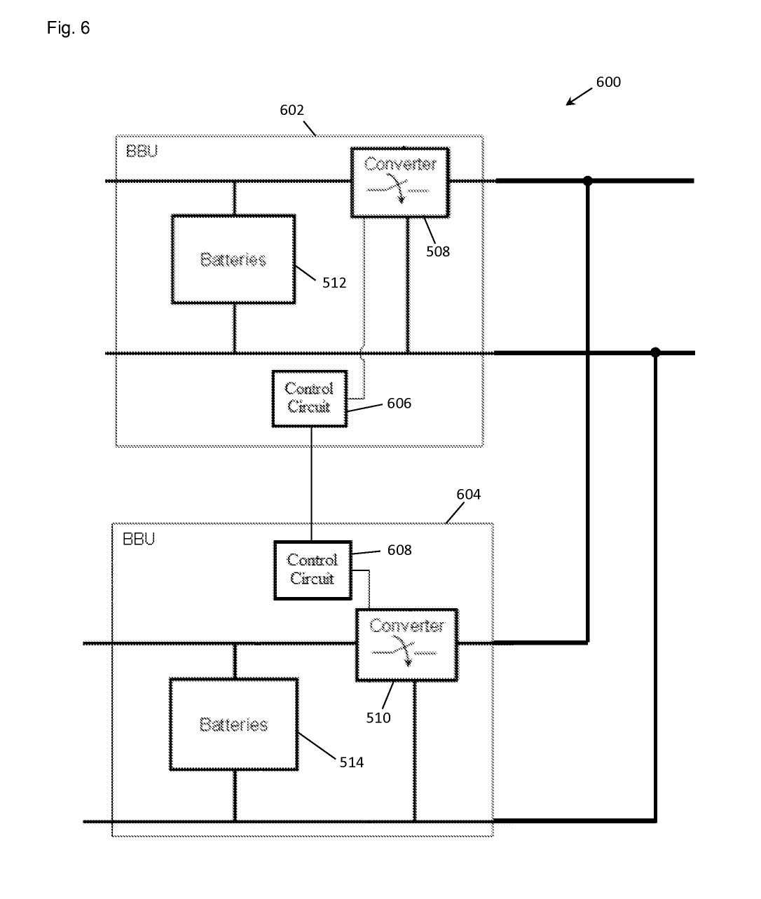

In some examples, a control circuit may be positioned in one or more of the BBUs. For example, FIG. 6 illustrates another system 600 including two BBUs 602, 604 substantially similar to the BBUs 502, 504 of FIG. 5. As shown in FIG. 6, the BBU 602 includes the converter 508 and the batteries 512 of FIG. 5 and a control circuit 606 coupled to the converter 508, and the BBU 604 includes the converter 510 and the batteries 514 of FIG. 5 and a control circuit 608 coupled to the converter 510.

Each control circuit 606, 608 may be substantially similar to the control circuit 110 of FIG. 1. For example, each control circuit 606, 608 may determine a remaining lifetime energy throughput of its corresponding batteries 512, 514 and control its corresponding converter 508, 510 as explained above. Additionally, each control circuit 606, 608 may determine a remaining lifetime energy throughput of the batteries in the other BBU and/or control the converter in the in the other BBU. For example, the control circuit 606 may determine a remaining lifetime energy throughput of the batteries 514 of the BBU 604, and/or control the converter 510 to adjust a battery current from the batteries 514 as explained above. Thus, each control circuit 606, 608 may receive one or more parameters to determine its corresponding battery's remaining lifetime energy throughput (as explained above) and/or another battery's remaining lifetime energy throughput (e.g., from a different BBU).

As shown in FIG. 6, the control circuits 606, 608 are in communication with each other. This may allow each control circuit 606, 608 to provide and/or receive information from each other. For example, the control circuit 606 may communicate the determined remaining lifetime energy throughput of the batteries 512 to the control circuit 608 and/or control the converter 510 as explained above. Additionally and/or alternatively, the control circuit 606 may communicate one or more parameters (e.g., sensed parameters, a preset number of discharges remaining as explained above, a battery capacity, etc.) of the batteries 512, the BBU 602, etc. to the control circuit 608 so that the control circuit 608 may determine the remaining lifetime energy throughput of the batteries 512.

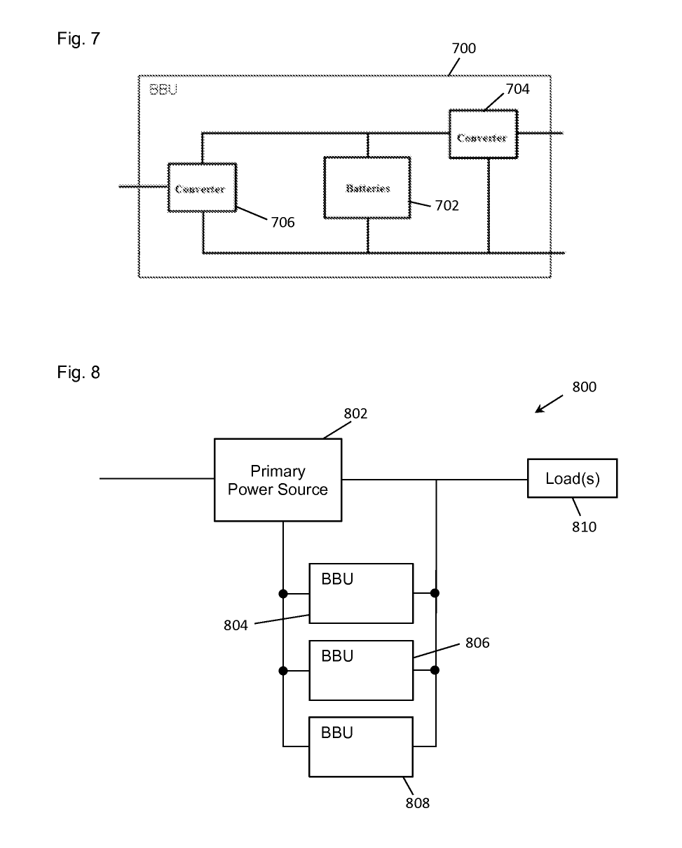

Although FIGS. 5 and 6 illustrate a particular BBU configuration, it should be apparent that other suitable BBU configurations may be employed without departing from the scope of the disclosure. For example, FIG. 7 illustrates another exemplary BBU 700 employable in the systems 500 of FIG. 5 and/or 600 of FIG. 6. The BBU 700 of FIG. 7 includes a converter 704 (e.g., an output converter 704), one or more rechargeable batteries 702 coupled to an input of the converter 704, and a converter 706 (e.g., an input converter 706) coupled to an input of the batteries 702 and the input of the converter 704. The batteries 702 and the output converter 704 of FIG. 7 may be substantially similar to the batteries 512, 514 and the converters 508, 510 of FIG. 5.

In the example of FIG. 7, the input converter 706 may receive an AC voltage and current or a DC voltage and current at its input, and output a DC voltage and current to the batteries 702. As such, the converter 706 may include, for example, one or more AC/DC rectifiers, DC/DC converters, etc. and be coupled to an AC source or a DC source.

FIG. 8 illustrates a system 800 including a primary power source 802 for providing power to one or more loads 810, and three BBUs 804, 806, 808 for providing backup power to the loads 810. Thus, if the primary power source 802 is unable to sustain the loads 810, one or more of the BBUs 804, 806, 808 may be activated to power the loads 810 for a period of time. For example, the BBUs 804, 806, 808 may sustain the loads 810 until one or more batteries in the BBUs reach an end of discharge, one or more batteries in the BBUs reach an EOL, until the primary power source 802 is able to provide adequate power to the loads 810, etc.

As shown in FIG. 8, the BBUs 804, 806, 808 are coupled in parallel. In particular, the inputs of the BBUs 804, 806, 808 are coupled in parallel and the outputs of the BBUs 804, 806, 808 are coupled in parallel. Alternatively, the inputs and/or the outputs of the BBUs 804, 806, 808 may not be coupled in parallel if desired. For example, the inputs of the BBUs 804, 806, 808 may not be coupled in the parallel and the outputs of the BBUs 804, 806, 808 may be coupled in parallel. In other embodiments, the outputs of the BBUs 804, 806, 808 may not be coupled in parallel and therefore can provide backup power to separate loads.

Additionally, each BBUs 804, 806, 808 of FIG. 8 may receive an AC voltage and current or a DC voltage and current at its input for charging rechargeable batteries in each BBU. For example, if the primary power source 802 includes an AC/DC rectifier, each BBU 804, 806, 808 may receive DC power (e.g., from the output of the primary power source 802). Additionally and/or alternatively, each BBU 804, 806, 808 may receive DC power from another suitable source. In other embodiments, each BBU may receive AC power and convert the AC power to DC power for charging the rechargeable batteries.

The BBUs 804, 806, 808 of FIG. 8 may be any suitable BBU including any one of the BBUs disclosed herein. For example, the BBU 804 may be substantially similar to the BBU 502 of FIG. 5, the BBU 806 may be substantially similar to the BBU 700 of FIG. 7, and the BBU 808 may be substantially similar to the BBU 602 of FIG. 6. In other examples, two or more of the BBUs 804, 806, 808 may have the same BBU configuration. For example, the BBUs 804, 806 may be substantially similar to the BBU 502 of FIG. 5 and the BBU 808 may be substantially similar to the BBU 700 of FIG. 7.

The primary power source 802 may include one or more converters (e.g., AC/DC rectifiers, DC/DC converters, etc.) and/or any other suitable power source.

Although the system 800 of FIG. 8 includes three BBUs 804, 806, 808, it should be apparent that more or less BBUs may be employed without departing from the scope of the disclosure. For example, the system 800 may include two BBUs, five BBUs, ten BBUs, etc.

The control circuits disclosed herein may include an analog control circuit, a digital control circuit (e.g., a digital signal processor (DSP), a microprocessor, a microcontroller, etc.), or a hybrid control circuit (e.g., a digital control circuit and an analog control circuit). Thus, the methods disclosed herein may be performed by a digital controller. Additionally, one or more portions of the control circuit may be an integrated circuit (IC).

In some examples, the control circuits may be a system control circuit (e.g., a system control card (SCC), etc.) of a particular system. For example, one control circuit may be utilized to control the converter(s) disclosed herein, a primary power source, etc. Alternatively, each converter, two or more converters, etc. may be controlled by a dedicated control circuit separate from a primary power source control circuit if desired. The dedicated control circuits and/or the system control circuits may be positioned within a particular BBU (e.g., as shown in FIG. 6) and/or external a BBU.

The batteries disclosed herein may be any suitable rechargeable battery including, for example, a Li-Ion battery, a NiMH battery, a NiCd battery, etc. In some embodiments, all of the batteries in a system may include the same type of rechargeable battery. For example, all of the batteries in a system may include Li-Ion batteries. In other embodiments, some of the batteries in a system may be one type of rechargeable batteries (e.g., Li-Ion batteries, etc.) and other batteries in the system may be another type of rechargeable batteries (e.g., NiCd batteries, etc.).

Additionally, the example systems disclosed herein may be employed in any suitable application including, for example, DC power applications and/or AC power applications. For example, the example systems may be used in telecommunication applications, information technology applications, etc. In some embodiments, the systems may be employed in enclosures (e.g., data racks, server cabinets, etc.) including, for example, stationary and/or modular enclosures.

Further, the systems may provide any suitable output power including, for example, AC power and/or DC power. In some embodiments, the systems may provide 5 VDC, 12 VDC, 24 VDC, 48 VDC, 400 VDC, 120 VAC, etc.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A system for providing power to a load, the system comprising:
a first converter;
a second converter;
a first rechargeable battery having a capacity and a number of remaining discharge cycles, and configured to output a current to the first converter;
a second rechargeable battery having a capacity and a number of remaining discharge cycles, and configured to output a current to the second converter; and
a control circuit coupled to the first converter and the second converter, the control circuit configured to determine a remaining lifetime energy throughput of the first rechargeable battery and the second rechargeable battery based on their respective capacity and number of remaining discharge cycles, and in response to the remaining lifetime energy throughput of the first rechargeable battery and the remaining lifetime energy throughput of the second rechargeable battery not being substantially equal, control the first converter to adjust the current from the first rechargeable battery to change a rate of decrease of the remaining lifetime energy throughput of the first rechargeable battery.

2. The system of claim 1 wherein the control circuit is configured to control the second converter to adjust the current from the second rechargeable battery.

3. The system of claim 2 wherein the control circuit is configured to control the first converter to adjust the current from the first rechargeable battery to a maximum current of the first rechargeable battery.

4. The system of claim 1 wherein the first converter and the first rechargeable battery are components of a battery backup unit.

5. The system of claim 4 further comprising an input converter configured to output a voltage and a current to the first rechargeable battery, wherein the input converter is a component of the battery backup unit.

6. The system of claim 4 wherein the battery backup unit is a first battery backup unit, wherein the control circuit include a first control circuit positioned in the first battery backup unit and a second control circuit in communication with the first control circuit, and wherein the second converter, the second rechargeable battery, and the second control circuit are components of a second battery backup unit.

7. The system of claim 1 wherein the control circuit includes a digital controller.

8. The system of claim 1 wherein the first converter includes a DC/DC converter.

9. The system of claim 1 wherein the first converter and the second converter each include an output coupled in parallel.

10. The system of claim 1 further comprising a third converter, and a third rechargeable battery having a capacity and a number of remaining discharge cycles and configured to output a current to the third converter; wherein the control circuit is coupled to the third converter and wherein the control circuit is configured to determine a remaining lifetime energy throughput of the third rechargeable battery based on its capacity and number of remaining discharge cycles.

11. The system of claim 1 wherein the control circuit is configured to control the first converter to adjust the current from the first rechargeable battery until the remaining lifetime energy throughput of the first rechargeable battery is substantially equal to the remaining lifetime energy throughput of the second rechargeable battery.

12. The system of claim 11 wherein the control circuit is configured to control the second converter to adjust the current from the second rechargeable battery.

13. The system of claim 12 wherein the control circuit is configured to control the first converter to adjust the current from the first rechargeable battery to a maximum current of the first rechargeable battery.

14. The system of claim 1 wherein the control circuit is configured to control the first converter to adjust the current from the first rechargeable battery to a maximum current of the first rechargeable battery.

15. The system of claim 14 wherein the control circuit is configured to control the first converter to adjust the current from the first rechargeable battery until the remaining lifetime energy throughput of the first rechargeable battery is substantially equal to the remaining lifetime energy throughput of the second rechargeable battery.

16. The system of claim 15 wherein the first converter and the first rechargeable battery are components of a battery backup unit.

17. The system of claim 16 wherein the control circuit includes a digital controller.

18. The system of claim 16 wherein the battery backup unit is a first battery backup unit, wherein the control circuit include a first control circuit positioned in the first battery backup unit and a second control circuit in communication with the first control circuit, and wherein the second converter, the second rechargeable battery, and the second control circuit are components of a second battery backup unit.

19. The system of claim 18 wherein the first converter includes a DC/DC converter.

20. The system of claim 18 wherein the first converter and the second converter each include an output coupled in parallel.
